(19) United States
(12) Patent Application Publication
(10) Pub. No.: US 2021/0331729 A1
(43) Pub. Date: Oct. 28, 2021

(54) UTILITY CART ELECTRIC POWERED - VOICE AND PROXIMITY ACTIVATED

(71) Applicant: Keith Maximilian Rudofsky, Fort Lauderdale, FL (US)

(72) Inventor: Keith Maximilian Rudofsky, Fort Lauderdale, FL (US)

(21) Appl. No.: 17/241,060

(22) Filed: Apr. 27, 2021

Related U.S. Application Data
(60) Provisional application No. 63/016,263, filed on Apr. 27, 2020.

(51) Int. Cl. B62B 5/00; B62B 3/00; B62B 3/02; B62B 3/14; G10L 17/22

(52) U.S. Cl. CPC B62B 5/0069; B62B 5/0053; B62B 5/0096; B62B 3/001; B62B 2301/05; B62B 3/1496; B62B 3/1492; G10L 17/22; B62B 3/02

(57) ABSTRACT

This invention offers a new hands-free electric powered utility cart, that is controlled by voice commands from the user, and by the cart detecting and tracking an electronic device or chip that a user simply carries or attaches to his or her garments.

Once the cart is powered-on, the user speaks voice commands such as “CART, FOLLOW ME” and the cart will follow approximately three feet behind the user wherever they walk. When the user wants the cart to stop, they can either stop walking, or use a voice command such as “CART, STOP”. The user can voice additional relevant commands such as “CART, FOLLOW TO MY RIGHT, or LEFT”, in order to control the cart's mode of operation.

All kinds of carrying baskets tailored to specific uses such as for beach, shopping, tools, golf equipment, and even a baby carriage are fitted to the cart's standardized chassis.

### FIELD OF THE INVENTION

The present invention relates to utility carts.

### BACKGROUND OF THE INVENTION

Many times, when we want to go to the beach or shop at a store, we have objects in our hands that prevent us from being able to pull or push a cart. Also, sometimes the objects in the cart are too heavy for us to physically pull or push the cart. In recent years, electric motors and rechargeable battery packs have become smaller and increasingly more power dense, thus these components can be used for applications from golf carts to small drivable cars for children.

More so, electronics and sensors have become increasingly sophisticated and smart, offering possibilities never before realized, such as voice activation of household lights and electronic appliances, as well as personal locating beacons (PLB's) and other handheld devices that can be detected and tracked from miles away.

A reasoned analysis of the available technologies would reveal that by combining battery powered electric motor capabilities, voice activated electronics, and locating sensor technology, that a hands-free utility cart can be developed for all kinds carrying tasks.

### BRIEF SUMMARY OF THE INVENTION

It is an object of the present invention to provide a hands-free utility cart that is controllable by detecting proximity to, and by voice commands from, it's user.

It is also an object of the present invention to provide said utility cart that can be used on all terrains, including asphalt, sand, snow, dirt, etc.

It is also an object of the present invention to provide said utility cart that can be used for a veritable plethora of functions, including but not limited to a beach cart, baby carriage, shopping cart, work tools cart, golf bags cart, etc. In doing so, it will be seen that the cart is comprised of a chassis, and a removable utility basket. The said chassis contains the electric motor(s), battery(s), electronics, wheels and other operational controls for the cart. Whereas the said utility basket is designed and styled for all sorts of specific applications. However, all said utility baskets shall include standardized attachment features for quickly connecting and disconnecting from the said chassis.

It is also an object of the present invention to provide said utility cart that, while intended for hands-free operation, does include a pull handle which can be used for complete manual operation.

It is also an object of the present invention that said utility cart can be folded-up and/or compacted for easy storage.

### BRIEF DESCRIPTION OF THE VIEW OF THE DRAWING

These and other features of the present invention will be more clearly understood from a consideration of the following description, taken in connection with the accompanying drawing, in which:

FIG. 1 illustrates one of many possible uses for the present invention, in a scenario wherein a utility basket for beach gear is seen attached to the chassis, and the chassis includes big round wheels suitable for use in sand.

### DETAILED DESCRIPTION OF THE DRAWINGS

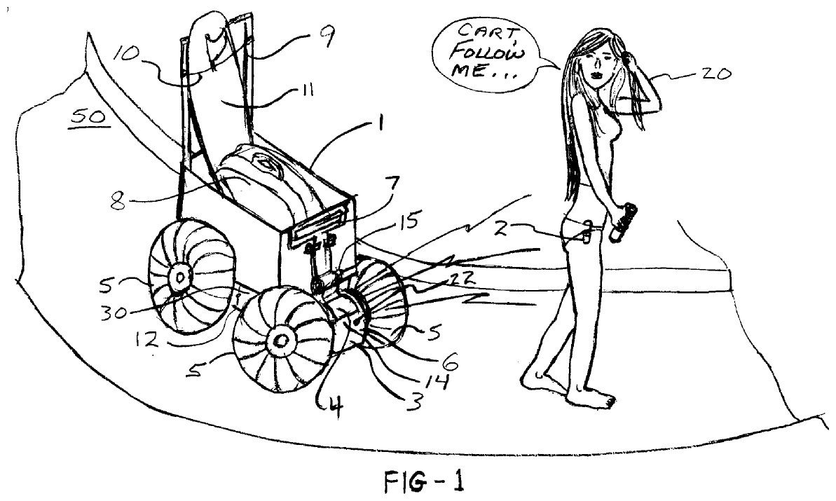

One of the many possible embodiments of the invention is shown in FIG. 1, and its sub-parts, for use as a hands-free beach cart is illustrated by reference numeral 50. The utility basket 1, is shown large enough to carry a large duffle bag 8, and also includes uprights 9, with a strap 10, for securing a surfboard or boogie board 11. The said utility basket 1, includes standardized features in order to connect to, and disconnect from, the chassis 12.

The chassis 12 contains a battery pack 30, electronics module 14, proximity sensor 4, electrically controlled steering mechanism 6, electric drive motor(s) 3, for forward and rearward movement. The wheels 5 attached to the chassis 12, are shown to be big round tires suitable for embodiment 50 to be used on sand as beach utility cart. The type of said wheels 5 fitted may vary greatly depending on the desired use of said cart, and for snow or sand may also be seen as full-track or half-track as is seen on common snow mobiles.

In operation the user 20 carries or wears an electronic device or chip 2, that is detected by the proximity sensor 4 located in said chassis 12. Once the utility cart is powered on by a button or switch 22, the user 20, can issue voice commands to control the operation of the cart. The electronics 14 will convert voice commands to the required electrical signals to modulate the electric motor for start, stop, and also for overriding the steering of the cart, which is nominally automated by the proximity sensor, perhaps to command the cart to change positions from one side of the user to the other side, as might be desired.

As an example, if the user voices a command such as “CART, FOLLOW ME”, or some variation thereof, as can be programmed into the electronics, the cart will move at a walking pace, while the proximity sensor 4 will ensure the cart remains approximately three feet behind the electronic device chip carried or worn by the user. Once the user voices a command such as “CART, STOP” or any desired electronically programmable variation thereof, the cart will come to a complete stop, whereby the user can approach the cart to load or remove any objects.

If for some reason the user 20 prefers the cart to follow on his or her right side or left side, a command can be voiced such as “CART, FOLLOW RIGHT” or any desired electronically programmable variation thereof, in which the cart will shift its path to approximately three feet to the right of the user 20. A different voice command will direct the cart to follow on the left, and another voice command will allow the user to adjust the following distance between the cart and the electronic device or chip 2 being carried.

If for some reason the battery dies or the cart electronics malfunction there is a manual pull handle 7 also connected to the chassis 12, which when deployed from its latch 15, will deactivate said drive motor(s) 3, and said electrically controlled steering mechanism 6, from said wheels, providing easy freewheeling of the cart for manual pulling.

While there have been described what are considered to be a preferred configuration of the present invention, it will be readily appreciated by those skilled in the art that modifications can be made without departing from the scope of the teachings herein. For at least such reason, therefore, resort should be had to the claims appended hereto for a true understanding of the scope of the invention.

I claim:

1. Apparatus comprising:
a chassis
a set of multi-terrain wheels. The style of wheels may vary according to the desired terrain.
first means of mounting said multi-terrain wheels to said chassis.
a utility basket, offered in countless variations and styles for specific utilities including but not limited to; beach gear, golfing, yardwork, shopping, food deliveries, or even configured as a baby carriage. All variations of said utility baskets include standardized attach/detach features for attaching to, and detaching from, said chassis.
second means of mounting said utility basket to said chassis by use of standardized mounting features.
an electronic device or chip, to be simply carried, or worn as a bracelet or necklace, or clipped on a key ring.
a proximity sensor, which detects and/or tracks the location of said electronic device or chip.
third means of said packaging said proximity sensor within said chassis.
an electric drive motor, or multiple electric drive motors, for turning said multi-terrain wheels.
fourth means of securing said drive motor(s) to said chassis.
fifth means of connecting said electric drive motors to said multi-terrain wheels.
an electrically controlled steering mechanism.
sixth means of securing said electrically controlled steering mechanism to said chassis.
seventh means of connecting said electrically controlled steering mechanism to one or more of said multi-terrain wheels.
an electronics module including but not limited to the function of receiving data from said proximity sensor and converting voice commands to electronic command signals, in order to control said electric drive motor(s) and said electrically controlled steering mechanism.
eighth means of securing said electronic module to said chassis.
a battery or multiple batteries, to provide electrical power to said electronics module, said electric drive motor(s), and said electrically controlled steering mechanism.
ninth means of attaching said batteries(s) to said chassis.
a manual pull handle for pulling said apparatus, that when deployed, decouples said electric drive motor(s), and said electrically controlled steering mechanism from said set of multi-terrain wheels.
tenth means of attaching said manual pull handle to forward side of said chassis.
